(19) United States
(12) Patent Application Publication
(10) Pub. No.: US 2006/0095559 A1
(43) Pub. Date: May 4, 2006

(54) Event counter and signaling co-processor for a network processor engine

(76) Inventors: Peter J. Mangan, Limerick (IE); Daniel G. Borkowski, Lunenburg, MA (US)

Correspondence Address: BUCKLEY, MASCHOFF, TALWALKAR LLC, 5 ELM STREET, NEW CANAAN, CT, 06840, US

(21) Appl. No.: 10/953,017

(22) Filed: Sep. 29, 2004

(51) Int. Cl. G06F 15/173

(52) U.S. Cl. 709/224

(57) ABSTRACT

According to some embodiments, an event flag signal generated by a network processor engine may be received at a co-processor. For example, a location in an event flag register at the co-processor may be set, and an event counter associated with that location may be incremented. The co-processor may also generate a notification signal in accordance with one or more locations in the event flag register and/or event counters.

### BACKGROUND

A processing system, such as a network processor, may include one or more processing elements that receive, transmit, and/or manipulate information. Moreover, in some cases the processing system may track how frequently certain events occur. For example, a network processor might gather statistics associated with the occurrence of particular errors and/or other events. Improving the efficiency of this type of information gathering may improve the performance of the processing system.

### BRIEF DESCRIPTION OF THE DRAWINGS

FIG. 1 is a block diagram of a network processor according to some embodiments.

FIG. 2 is a block diagram of a network processor engine according to some embodiments.

FIG. 3 is a block diagram of an event counter and signaling co-processor according to some embodiments.

FIG. 4 illustrates a method according to some embodiments.

FIG. 5 is a block diagram of an event counter and signaling co-processor according to some embodiments.

### DETAILED DESCRIPTION

Some embodiments described herein are associated with a “network processor.” As used herein, the phrase “network processor” may refer to, for example, an apparatus that facilitates an exchange of information via a network, such as a Local Area Network (LAN), or a Wide Area Network (WAN). By way of example, a network processor might facilitate an exchange of information packets in accordance with the Fast Ethernet LAN transmission standard 802.3-2002® published by the Institute of Electrical and Electronics Engineers (IEEE). Similarly, a network processor may process and/or exchange Asynchronous Transfer Mode (ATM) information in accordance with ATM Forum Technical Committee document number AF-TM-0121.000 entitled “Traffic Management Specification Version 4.1” (March 1999). Examples of network processors include a switch, a router (e.g., an edge router), a layer 3 forwarder, a protocol conversion device, and the INTEL® IXP4XX product line of network processors.

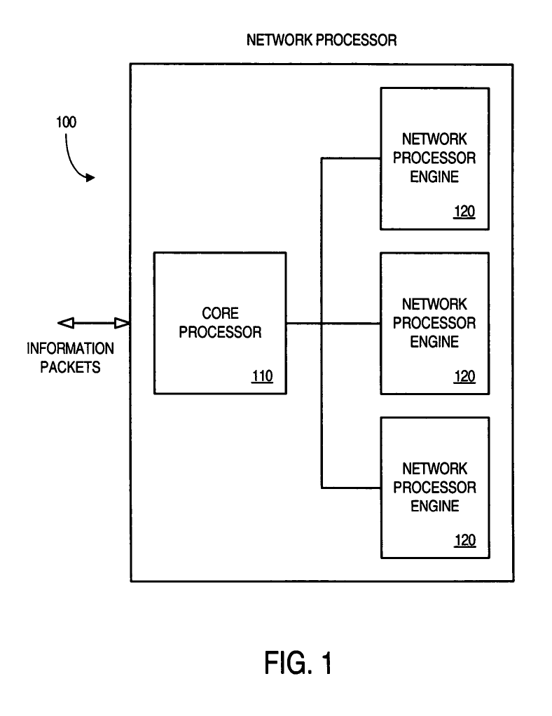

FIG. 1 is a block diagram of a network processor 100 according to some embodiments. The network processor 100 may include a core processor 110 (e.g., to process information packets in the control plane). The core processor 110 may comprise, for example, a Central Processing Unit (CPU) able to perform intensive processing on an information packet. By way of example, the core processor 110 may comprise an INTEL® StrongARM core CPU.

The network processor 100 may also include a number of high-speed network processor engines 120 (e.g., microengines) to process information packets in the data plane. Although three network processor engines 120 are illustrated in FIG. 1, note that any number of network processor engines 120 may be provided. Also note that different network processor engines 120 may be programmed to perform different tasks. By way of example, one network processor engine 120 might receive input information packets from a network interface. Another network processor engine 120 might process the information packets, while still another one forwards output information packets to a network interface.

The network processor engines 120 might comprise, for example, Reduced Instruction Set Computer (RISC) microengines adapted to perform information packet processing. According to some embodiments, a network processor engine 120 can execute multiple threads of code or “contexts” (e.g., a higher priority context and a lower priority context).

In some cases, the network processor 100 may gather information associated with the occurrence of certain types of events. For example, a network processor engine 120 might track the occurrence of errors and other statistics. This information may then be reported to the core processor 110 (e.g., after ten ATM cells have been received) and/or be used to adjust the operation of the network processor 100 (e.g., by implementing an ATM traffic shaping algorithm).

Keeping track of such information, however, can make it difficult for a network processor engine 120 to perform high-speed operations associated with information packets. For example, the performance of the network processor 100 might be reduced because code executing on a network processor engine 120 is using clock cycles to access memory and/or increment counters associated with an event.

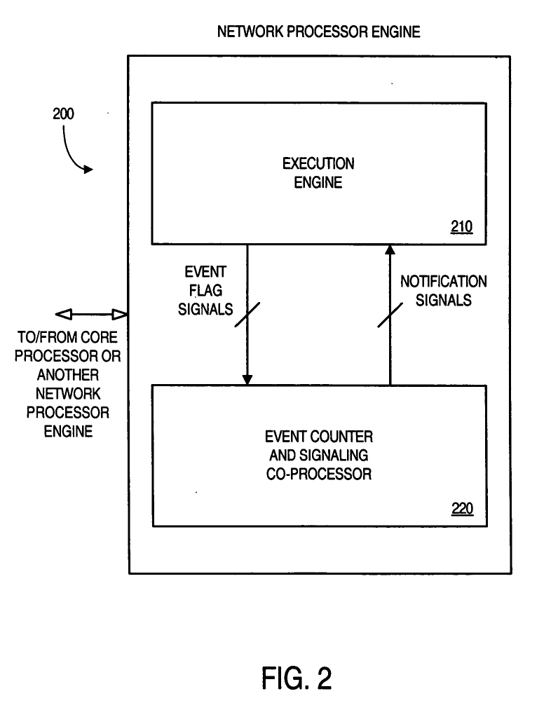

FIG. 2 is a block diagram of a network processor engine 200 according to some embodiments. In this case, the network processor engine 200 includes an execution engine 210 that may, for example, process information packets in the data plane. According to some embodiments, the execution engine 210 is able to execute multiple threads. For example, a first context might detect that an error has occurred (e.g., a queue has overflowed) and set a pre-determined error flag bit in local memory. A second context might poll the error flag bit on a periodic basis and report the error to a core processor. The second context might, for example, report the error by storing information into a debug First-In, First-Out (FIFO) queue. Although such an approach might reduce the data path overhead associated with the first context (e.g., by offloading part of the task to the second context), it can be difficult it determine how many times an error has occurred.

According to some embodiments, the network processor engine 200 further includes an event counter and signaling co-processor 220. The co-processor 220 might, for example, be formed on the same die as the execution engine 210. According to other embodiments, the co-processor 220 is formed on a separate die. The co-processor 220 may receive one or more event flag signals from the execution engine 210 and may also provide one or more notification signals to the execution engine 210. According to some embodiments, the network processor engine 200 also includes an instruction bus between the execution engine 210 and the co-processor 220.

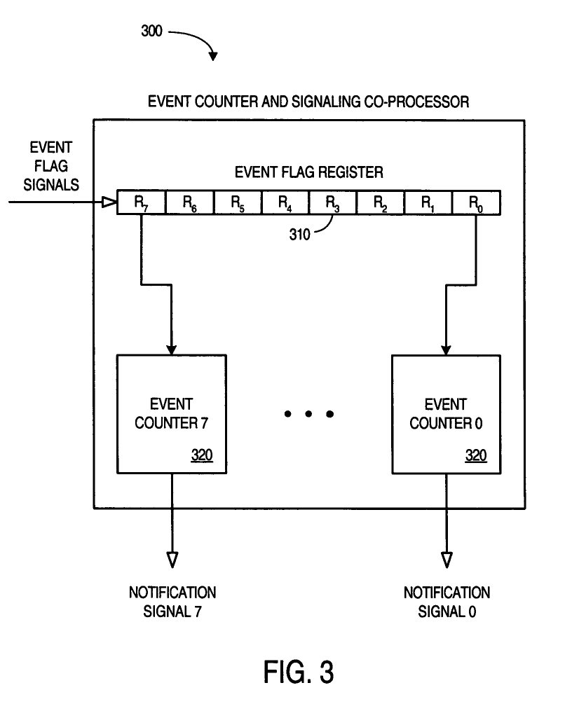

FIG. 3 is a block diagram of an event counter and signaling co-processor 300 according to some embodiments. The co-processor 300 may include an event flag register 310 having a plurality of locations associated with a plurality of potential event flag signals. For example, the event flag register 310 illustrated in FIG. 3 has eight bits (R₀ though R₇), and each bit might be associated with a different type of error. The value of each location may to be based on one or more event flags signal received from an execution engine. That is, the execution engine may set, or re-set, each bit in the event flag register 310 as appropriate (e.g., bit R₂ might be set to “1” when a time-out error occurs).

The co-processor 300 also has a plurality of counters 320, and each counter 320 may be adapted to be incremented in accordance with an associated location in the event flag register 310. For example, a counter 320 might be incremented whenever the associated bit in the event flag register 310 transitions from “0” to “1” (a positive edge trigger). Similarly, a counter 320 might be incremented whenever the associated bit in the event flag register 310 transitions from “1” to “0” (a negative edge trigger). As another example, a counter 320 might only be incremented when the associated bit remains “1” (or, in yet another example, “0”) for a predetermined number of cycles.

According to some embodiments, the operation of each counter 320 is configurable. For example, during an initialization process an execution engine might arrange for two counters 320 to have positive edge triggers, four counters 320 to have negative edge triggers, one counter 320 to increment only when the associated bit has been “1” for three consecutive cycles, and one counter 320 to never increment.

Each counter 320 may also generate a notification signal. For example, a counter 320 might provide a notification signal to an execution engine when the counter 320 reaches a pre-determined value (e.g., a signal might be generated when the value in the counter 320 reaches six). According to some embodiments, the pre-determined value is configurable. For example, during an initialization process an execution engine might arrange for five counters 320 to generate a notification signal when they reach ten and for three counters 320 to generate a notification signal when they reach the value “1.” According to some embodiments, each counter 320 may be configured to wrap-around when it reaches a particular value (e.g., a counter 320 might wrap from the value eight to zero).

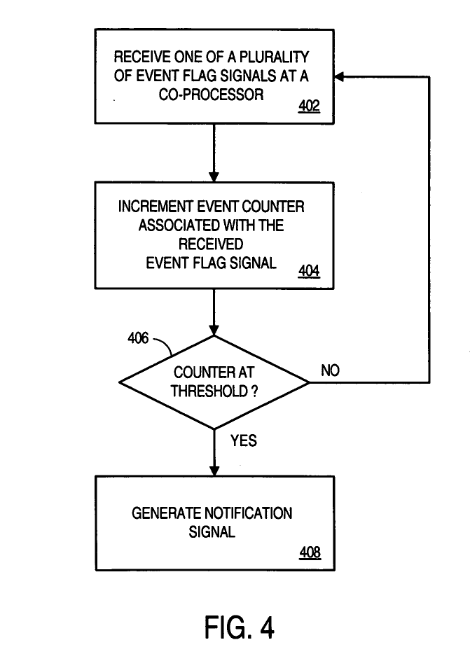

FIG. 4 illustrates a method that might be performed, for example, by the event counter and signaling co-processor 300 according to some embodiments. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine results in performance according to any of the embodiments described herein.

At 402, one or more event flag signals are received at a co-processor. For example, a first context executing at an execution engines might determine that a particular error, time-out, or other packet-processing event has occurred. Based on this determination, the first context might provide an event flag signal to the co-processor. According to some embodiments, a co-processor may receive more than one event flag simultaneously.

At 404, one or more event counters associated with the received event flag signals are incremented. The event counters might be incremented, for example, upon: (i) a transition of an event flag signal from low to high, (ii) a transition of an event flag signal from high to low, (iii) an event flag signal remaining high for a pre-determined number of cycles, or (iv) an event flag signal remaining low for a pre-determined number of cycles.

At 406, it is determined if the incremented event counter has reached a threshold value. According to some embodiments, the threshold value is configurable (e.g., the value can be set by another device). If the incremented event counter has not reached the threshold value, the process continues at 402 (e.g., when another even flag signal is received).

If the incremented event counter has reached the threshold value at 406, a notification signal is generated at 408. The notification signal might be provided, for example, to a second context executing at the execution engine. The notification signal may then be used, for example, to track errors (e.g., fatal errors) or other statistics.

According to some embodiments, the notification signal is used to implement a shaping algorithm, such as an ATM traffic management shaping algorithm. As another example, the notification signal might be used to implement a scheduling algorithm, such as for Inverse Multiplexed ATM (IMA) Control Protocol (ICP) cells. As still another example, the notification signal might be used to implement a throttling algorithm (e.g., to throttle Ethernet traffic when time sensitive voice traffic flows through the same network processor engine).

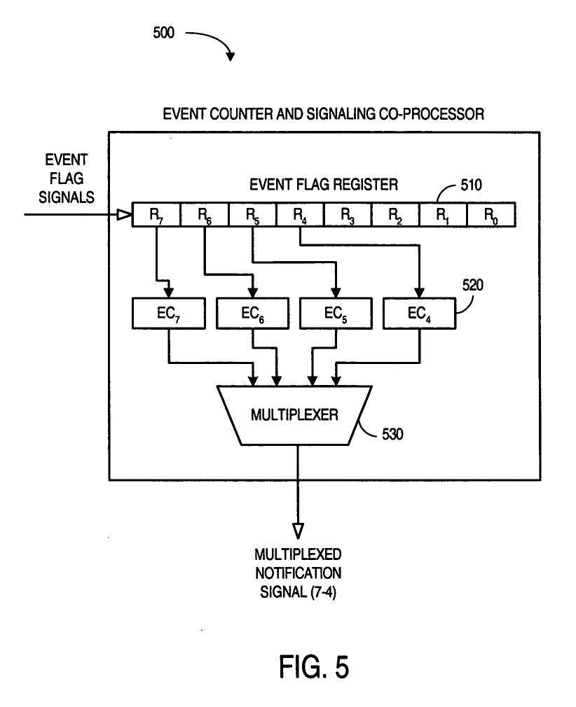

FIG. 5 is a block diagram of an event counter and signaling co-processor 500 according to some embodiments. As before, the co-processor 500 includes an event flag register 510 with a plurality of bits (R₀ though R₇) that can be associated with different types of events. The value of each location may to be set by event flag signals received from an execution engine.

The co-processor 500 also has a plurality of event counters 520 (EC₀ through EC₇), and each event counter 520 may be adapted to be incremented in accordance with an associated location in the event flag register 510 (e.g., using positive or negative edge triggers).

Each event counter 520 may also generate an output signal. For example, an event counter 520 might generate an output signal when a threshold value is reached. According to this embodiment, a subset of the event counter outputs (from EC₄ through EC₇) are provided to a multiplexer 530. The multiplexer 530 then generates a multiplexed notification signal when any of those event counter outputs are true (e.g., all of the event counter outputs may be combined via a Boolean OR operation). Although a single multiplexer 530 is illustrated in FIG. 5, the co-processor 500 might include any number of multiplexers (e.g., a second multiplexer might receive the outputs from event counters EC₀ through EC₃).

When the execution engine receives the multiplexed notification signal, it may then read the values stored in the event counters 520 to determine what actions should be taken (e.g., whether or not information should be reported to a core processor).

According to some embodiments, the subset of event counter outputs received by a multiplexer is configurable. For example, during an initialization process an execution engine might arrange for one multiplexer to receive outputs from EC₀, EC₁, and EC₅. According to some embodiments, information from a subset of the locations in the event flag register 510 is similarly multiplexed and used to provide a notification signal (and this type of arrangement might also be configurable).

As described herein, event flag signals from a network processor engine to a co-processor may be used to update an event signal register and/or an event counter. According to some embodiments, the event flag signals are associated with an instruction that can be used to adjust values in the co-processor. For example, a network processor engine (or execution engine) may use an instruction to cause the co-processor to update an event signal register and/or an event counter. In some cases, an execution engine may issue such an instruction to a co-processor via a co-processor bus. Note that the instruction might have one or more bit positions corresponding to one or more locations in an event signal register and/or in event counters.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to counters that are incremented to track events, embodiments might instead use counters that are initialized with a value and then are subsequently decremented each time an event occurs (e.g., and a notification signal might be provided when the counter reaches zero). In addition, although some examples have been described with respect to a network processor, embodiments may be used in connection with other types of processing systems. Moreover, although software or hardware have been described as performing various functions, such functions might be performed by either software or hardware (or a combination of software and hardware).

The several embodiments described herein are solely for the purpose of illustration. Persons skilled in the art will recognize from this description other embodiments may be practiced with modifications and alterations limited only by the claims.

What is claimed is:

1. A method, comprising:
receiving at a co-processor an event flag signal from a network processor engine, wherein the received event flag signal is one of plurality of potential event flag signals; and
incrementing at the co-processor an event counter associated with the received event flag signal, wherein the incremented event counter is one of a plurality of event counters, each event counter being associated with a potential event flag signal.

2. The method of claim 1, wherein the event counter is incremented upon at least one of: (i) a transition of the event flag signal from low to high, (ii) a transition of the event flag signal from high to low, (iii) the event flag signal remaining high for a pre-determined number of cycles, or (iv) the event flag signal remaining low for a pre-determined number of cycles.

3. The method of claim 1, wherein the event flag signal is received from a first context executing at the network processor engine and further comprising:
providing a notification signal to a second context executing at the network processor engine.

4. The method of claim 3, wherein the notification signal is associated with at least one of: (i) a statistic, (ii) an error, (iii) a shaping algorithm, (iv) a scheduling algorithm, or (v) a throttling algorithm.

5. The method of claim 1, further comprising:
providing a notification signal when the incremented event counter reaches a pre-determined level.

6. The method of claim 5, wherein the pre-determined level is configurable in the co-processor.

7. The method of claim 1, further comprising:
providing a multiplexed notification signal upon at least one of: (i) when any of a subset of potential event flag signals are set, or (ii) when any of a subset of event counters satisfy a pre-determined condition.

8. The method of claim 7, wherein the subset is configurable in the co-processor.

9. The method of claim 1, wherein the co-processor and network processor engine are formed on the same die.

10. The method of claim 1, wherein the event flag signal is associated with at least one of: (i) an error, (ii) a statistical value, (iii) a time-out, or (iii) packet processing.

11. A medium storing instructions adapted to be executed by a processor associated with a second simulator to perform a method, said method comprising:
receiving a flag signal from a processor, wherein the received flag signal is one of plurality of potential flag signals; and
adjusting a counter associated with the received flag signal, wherein the incremented counter is one of a plurality of counters, each counter being associated with a potential flag signal.

12. The medium of claim 1 1, wherein the counter is incremented upon at least one of: (i) a transition of the flag signal from low to high, (ii) a transition of the flag signal from high to low, (iii) the flag signal remaining high for a pre-determined number of cycles, or (iv) the flag signal remaining low for a pre-determined number of cycles.

13. The medium of claim 11, wherein the flag signal is received from a first context executing at the processor and further comprising:
providing a notification signal to a second context executing at the processor, wherein the provided signal is associated with at least one of: (i) a statistic, (ii) an error, (iii) a shaping algorithm, (iv) a scheduling algorithm, or (v) a throttling algorithm.

14. The medium of claim 13, wherein the signal is provided an incremented counter reaches a pre-determined level, and the pre-determined level is configurable.

15. The medium of claim 14, further comprising:
providing a multiplexed notification signal upon at least one of: (i) when any of a configurable subset of potential event flag signals are set, or (ii) when any of a subset of configurable counters satisfy a pre-determined condition.

16. The medium of claim 15, wherein the multiplexed notification signal is associated with at least one of: (i) a statistic, (ii) an error, (iii) a shaping algorithm, (iv) a scheduling algorithm, or (v) a throttling algorithm.

17. An apparatus, comprising:
an event flag register having a plurality of locations associated with a plurality of potential event flag signals, wherein the value of each location is to be based on an associated event flag signal received from a network processor engine; and
a plurality of counters, each counter to be adjusted in accordance with an associated location in the event flag register.

18. The apparatus of claim 17, further comprising:
a multiplexer to provide a notification signal in accordance with a subset of the locations in the event flag register.

19. The apparatus of claim 18, wherein the multiplexer is configurable with respect to the subset.

20. The apparatus of claim 17, further comprising:
a multiplexer to provide a notification signal in accordance with a subset of the event counters.

21. The apparatus of claim 20, wherein the multiplexer is configurable with respect to the subset.

22. A system, comprising:
a core processor; and
a plurality of network processor engines, wherein each network processor engine includes:
a multi-threaded execution engine, and
a co-processor, comprising:
an event flag register having a plurality of locations associated with a plurality of potential event flag signals, wherein the value of each location is to be based on an associated event flag signal received from the execution engine, and
a plurality of counters, each counter to be incremented in accordance with an associated location in the event flag register.

23. The system of claim 22, wherein an event flag signal is received from a first thread executing on a first execution engine of a first network processor engine, and the co-processor of the first network processor engine is to provide a notification signal to a second thread executing on the first execution engine in accordance with at least one of (i) at least some of locations in the event flag register, or (ii) at least some of the event counters.

24. The system of claim 23, and wherein the second thread is to provide a signal to the core processor based on the notification signal.

25. The system of claim 22, wherein each co-processor further comprises:
a configurable multiplexer to generate the notification signal.
